(19) United States
(12) Patent Application Publication
(10) Pub. No.: US 2009/0088965 A1
(43) Pub. Date: Apr. 2, 2009

(54) ENHANCEMENT FOR NAVIGATION SYSTEMS FOR USING WEATHER INFORMATION WHEN PREDICTING A QUICKEST TRAVEL PATH

(75) Inventors: ERIK J. BURCKART, RALEIGH, NC (US); ANDREW J. IVORY, WAKE FOREST, NC (US); MATTHEW J. SHEARD, MORRISVILLE, NC (US); AARON K. SHOOK, MORRISVILLE, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/866,139

(22) Filed: Oct. 2, 2007

(51) Int. Cl. G01C 21/34

(52) U.S. Cl. 701/201; 701/210

(57) ABSTRACT

The present invention discloses a software method for determining a travel path. The software method can identify a point of origin, a travel destination, and a travel time. Multiple different possible travel pathways between the point of origin and the travel destination can be determined. Predicted weather conditions for each of the travel pathways for a time of travel can be ascertained. Time estimates for each of the travel pathways can be adjusted based on the predicated weather conditions for each of the travel pathways. At least one of the determined travel pathways can be presented based at least in part upon the time estimates that have been adjusted for the predicted weather conditions and historical data about the given pathways with similar weather to that which is being predicted. In one embodiment; the software method can be performed by a Global Positioning System (GPS) equipped motor vehicle navigation system.

### BACKGROUND

1. Field of the Invention

The present invention relates to navigation systems and travel path software solutions, and more particularly; to an enhancement for navigation systems for using weather information when predicting a quickest travel path.

2. Description of the Related Art

The global positioning system (GPS) is a fully functional global navigation satellite system (GNSS). The system utilizes at least twenty four medium Earth orbit satellites that transmit microwave signals to allow a GPS receiver to determine its location, speed, and direction. The GPS system is maintained by the government and is provided free for civilians. A very common use of the GPS system is for navigation. Consumers often buy GPS receivers and use them in their cars. Locations can he entered using the GPS receiver and the receiver can plot a course to the desired destination. The GPS receiver can then display appropriate maps and directions to direct the consumer to their desired destination.

When being used for navigation, GPS receivers attempt to find the quickest and/or shortest route possible for the user. The GPS receiver can use available information to attempt to make a determination of which route would he the quickest for the user. Existing navigation systems are able to monitor traffic, accidents, and other current conditions and to redirect a user's route dynamically in light of these conditions.

What often happens is that once delays occur, a driver is stuck in a traffic jam with no ability to maneuver around it to get to an alternate route. Choices of alternative routes and resultant delays often vary directly in proportion to a drivers distance from a traffic flow problem. That is, if a driver is warned a sufficient distance in advance, an alternative route can be selected that adds a minimal delay over an original route assuming normal traffic conditions. As the distance to the traffic flow problem decreases, alternative route delay times generally increase. A way to factor in forecasted weather conditions and to intelligently combine the forecast information with historical traffic problem areas is needed to determine a superior route at a beginning of travel or during a travel planning stage so that a user is never stuck in traffic delays in the first place.

### SUMMARY OF THE INVENTION

The present invention discloses a software service that uses weather forecasts and historical information concerning travel paths and their traversal times in various weather conditions to determine a travel path having a shortest estimated time in light of weather conditions. The software service can he part of a navigation system and/or can be integrated into a mapping software program. For example, a GPS equipped in-vehicle navigation system using the disclosed solution can compute a best driving path based upon predicted weather conditions. In another example, a mapping service, such as MAPQUEST, can provide improved results using the disclosed solution by considering predicted weather conditions when mapping a travel pathway from a source to a destination. In one embodiment, period updates can be obtained from a weather service, which can cause weather forecasts to change, which in turn can cause a suggested travel pathway to dynamically change, in another embodiment, navigation systems equipped to utilize weather forecasts can provide data concerning actual driving times and actual weather conditions, which can be used to populate the historic data and to otherwise establish a training feedback loop.

The present invention can be implemented in accordance with numerous aspects consistent with the material presented herein. For example, one aspect of the present invention can include a software method for determining a travel path. The software method can identify a point of origin, a travel destination, and a travel time. Multiple different possible travel pathways between the point of origin and the travel destination can be determined. Predicted weather conditions for each of the travel pathways can be ascertained for a time of travel. Time estimates for each of the travel pathways can be adjusted based on the predicated weather conditions for each of the travel pathways. At least one of the determined travel pathways can be presented based at least in part upon the time estimates that have been adjusted for the predicted weather conditions.

Another aspect of the present invention can include a navigation device that includes a user interface and a travel path determination engine. The user interface can he configured for inputting a point of origin and a destination and for presenting a programmatically determined travel pathway for traveling from the input point of origin to the destination. The travel path determination engine can be a software based computing engine of the navigation device that is configured to determine a best travel pathway based at least in part upon a set of estimated travel times along a plurality of different potential travel pathways. The estimated travel time can be based at least in part upon predicted weather conditions, where a different travel time results from different predicted weather conditions.

Still another aspect of the present invention can include a system for determining a travel path that includes a weather forecast source, a mapping data store, a historic data store, and a travel path determination engine. The weather forecast source can be configured to predict weather conditions. The mapping data store can include mapping data configured to be used to determine valid travel paths from a point of origin to a destination. The historic data store can include records indicating travel path portions and estimated times to travel along those travel path portions. Different weather conditions can be associated with the travel path portions, each weather condition being associated with a different estimated time to travel along the travel path portion in the weather condition. The travel path determination engine can be a software based computing engine configured to determine a travel path using the mapping data store. The determined travel path can be one having a shortest duration in view of the predicted weather conditions from the weather forecast source and in further view of the records contained in the historic data store, which are used determine a travel time for the travel path given the predicted weather conditions.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system in which travel path determinations are made based at least in: part upon forecasted weather conditions.

FIG. 2 is a schematic diagram of a sample set of interfaces for a navigation system that uses weather forecasts and historical weather dependent travel information when predicting a shortest travel path in accordance with an embodiment of the inventive arrangements disclosed herein.

FIG. 3 is a flow chart of a method for a navigation device that selectively uses weather forecasts when determining a quickest travel path.

### DETAILED DESCRIPTION OF THE INVENTION

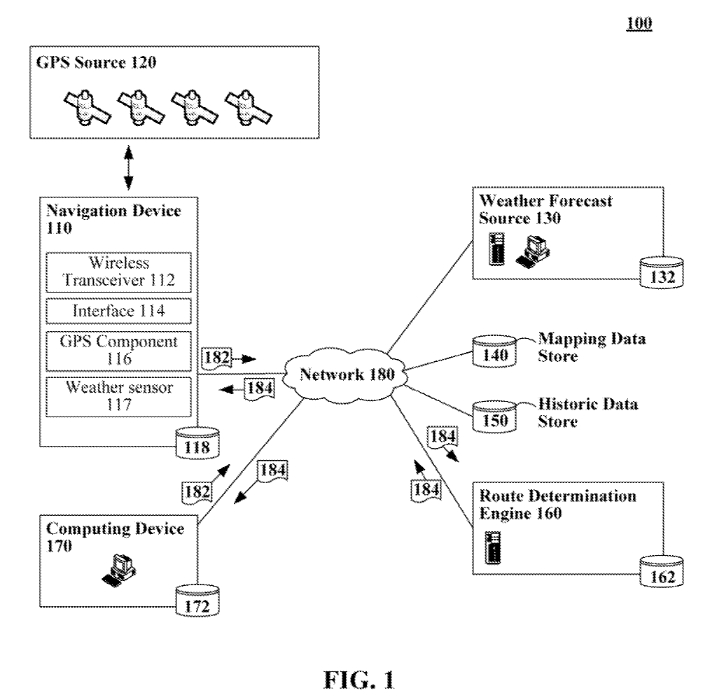

FIG. 1 is a schematic diagram of a system 100 in which travel path determinations are made based at least in part upon forecasted weather conditions. In system 100, a navigation device 110 or a computing device 170 conveys a travel request 182 to a travel path determination engine 160. Prom the request 182, the engine 160 can determine a point of origin, a destination, and a travel time. The travel path determination engine 160 can then use mapping data from mapping data store 140 to determine a multiple connectivity paths (N paths) for traveling from the point of origin to the destination. The engine 160 can then access weather forecast source 130 to determine predicted weather along each of the N travel paths for the estimated travel times. A historical data store 150 can be queried, which contains historic traffic flow data for different travel pathways and pathway portions given different weather conditions. An estimated time of travel for a given weather condition (i.e., the condition predicted by the weather forecast source 130) can be computed based upon the historic data maintained in data store 150. Estimated travel times can be assigned to each of the N travel paths based on predicted travel times in view of the predicted weather conditions. The determination engine 160 can determine a best (or a top M) travel path(s) 184 based at least in part upon estimated time of travel. These travel path(s) 184 can be conveyed to the travel requesting device 110 or 170.

In one embodiment, the navigation device 110 can include a capability to determine its present position, such as through a Global Positioning System (GPS) component 116, which uses signals from one or more GPS sources 120 to determine geographic coordinates for the navigation device 110. The navigation device 110 can also include a wireless transceiver 112 for exchanging digitally encoded content over a network 180. Further, an interface 114 for accepting input and presenting travel paths 184 can be included in the device 110.

The navigation device 110 can be part of a system that includes a weather sensor 117, such as temperature sensor, a precipitation sensor, and the like. For example, an automobile can be equipped with an in-vehicle navigation system 110 as well as one or more ambient weather sensors 117. Ambient weather conditions detected by sensor 117 can be conveyed along with actual travel times to the historic data store 150 to ensure content of data store 150 is accurate and up-to-date. Actual performance information for different ambient weather conditions (detected by sensor 117) can also be used by the path determination engine 160 to establish a feedback/training loop designed to improve the engine 160's accuracy over time.

As used herein, the travel path determination engine 160 can be a software engine used to determine a travel path 184. In one embodiment, the engine 160 can be integrated within a stand-alone navigation device 110. In another embodiment, the engine 160 can be implemented as software hosted on a network server, which provides travel path determinations in real-time or otherwise to remotely located devices 110, 170.

The network 180 can include any hardware/software/and firmware necessary to convey digital content encoded within carrier waves, Content can be contained within analog or digital signals and conveyed through data or voice channels and can be conveyed over a personal area network (PAN) or a wide area network (WAN). The network ISO can include local components and data pathways necessary for communications to be exchanged among computing device components and between integrated device components and peripheral devices. The network 180 can also include network equipment, such as routers, data lines, hubs, and intermediary servers which together form a packet-based network, such as the Internet or an intranet. The network 180 can further include circuit-based communication components and mobile communication components, such as telephony switches, modems, cellular communication towers, and the like. The network ISO can include line based and/or wireless communication pathways.

The various data stores 118, 132, 140, 150, 162, and 172 of system can each be a physical or virtual storage spaces configured to store digital information. The data stores 118, 132, 140, 150, 162, and 172 can be physically implemented within any type of hardware including, but not limited to, a magnetic disk, an optical disk, a semiconductor memory, a digitally encoded plastic memory, a holographic memory, or any other recording medium. The data stores 118, 132, 140, 150, 162, and 172 can he a stand-alone storage unit as well as a storage unit formed from a plurality of physical devices. Additionally, information can be stored within the data stores 118, 132, 140, 150, 162, and 172 in a variety of manners. For example, information can be stored within a database structure or can be stored within one or more files of a file storage system, where each file may or may not be indexed for information searching purposes. Further, data stores 118, 132, 140, 150, 162, and 172 can optionally utilize one or more encryption mechanisms to protect stored information from unauthorized access.

The following operational example can be used to indicate how system 100 functions in a concrete situation. In the example, a user can be planning a driving trip through New York City at a time that a rain storm is forecasted by forecast source 130. Historic data 150 can specify that there are many problem flooding areas on the Grand Central Parkway, which can cause hours of traffic delays. The navigation device 110 using the route determination engine 160 can utilize the historic data store 150 information together with the weather forecast for the time of intended travel to make an intelligent decision (statistically based using deterministic algorithms) regarding how long of an additional travel duration, if any, will result from the predicted rain and possible flooding. This additional travel duration will be compared against times for driving along alternative travel paths. A navigation device 110 determined travel path 184 can represent the shortest possible route by duration in view of the predicted weather.

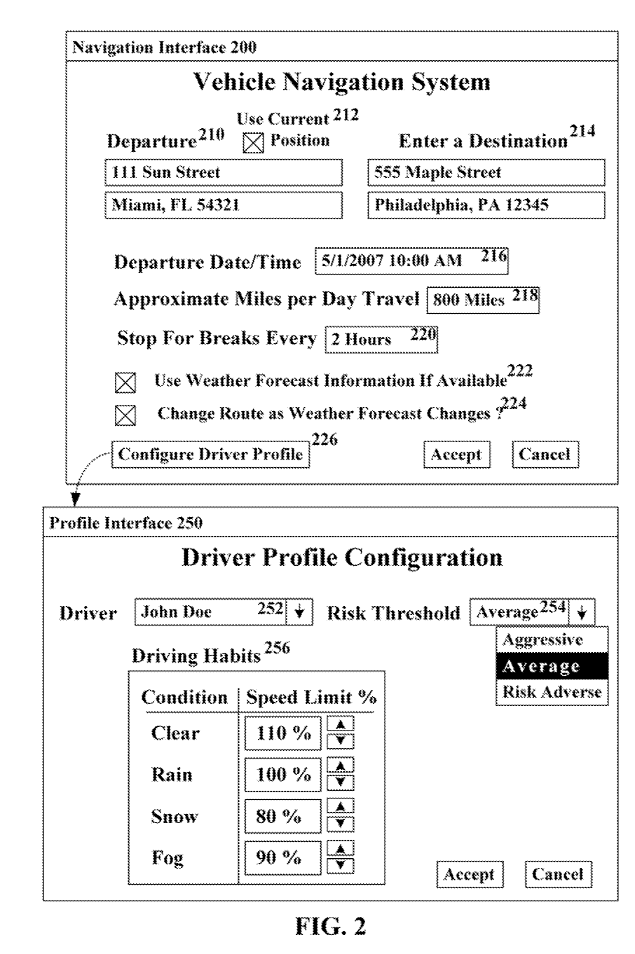

FIG. 2 is a schematic diagram of a sample set of interfaces 200, 250 for a navigation system that uses weather forecasts and historical weather dependent travel information when predicting a shortest travel path in accordance with an embodiment of the inventive arrangements disclosed herein. The interfaces 200, 250 can be one arrangement for interface 114 of system 100.

As illustrated, navigation interface 200 is a user interface for a vehicle navigation system. The interface 200 can include an input element 210 for specifying a point of origin and another 214 for specifying a destination. On option 212 can be provided to use a current position of the navigation device as the point of origin.

Interface 200 can permit a user to specify details that are used to correlate a time at which a vehicle is at a specific geographic position along a travel path. For example, a departure time 216, an approximate number of travel miles per day 218, and an indicator 220 for an iteration for taking breaks when travel trig can be specified for a trip via interface 200. Interface 200 can also include an option 222 of whether weather forecast information is to be used to adjust time estimates along different travel paths. An different option 224 can be used to dynamically permit changes to be made to a determined travel path as weather forecast information changes. Finally, a button 226 to configure a driver profile can exist, which when selected causes a user profiling interface 250 to appear.

In the user profiling interface 250, one or more drivers 252 can establish their driving patterns, which are taken into consideration when estimating travel times. One component of the profile can include a risk threshold 254, which represents whether a driver wishes to level of risk that a driver wishes to he applied to uncertain weather conditions. For example, an aggressive driver can desire to chance possible weather induced delays, when a chance of the delays is relatively moderate. A risk adverse driver may want to avoid even a slight chance of long delays due to adverse weather conditions in favor of a more predictable travel time. An average setting for a risk threshold 254 is for users falling between the two extremes of handling weather related risks.

A driving habits 256 section of interface 250 can permit a user to specify their personal driving velocities for different types of conditions. For example, the user of interface 250 indicates that they generally drive at one hundred and ten percent of the speed limit in clear weather conditions. In rainy conditions the driver can drive at one hundred percent of the posted speed limit of a roadway on average. In snow, a user can average eighty percent of the speed limit. And in fog, the user can drive at an average of ninety percent of the posted speed limit.

The various conditions and settings (e.g., items 216, 218, 220, 254, and 256) shown in interfaces 200, 250 demonstrate that many driver specific settings can be established that predict how a driver will behave in various weather conditions and when and where a driver is likely to encounter predicted weather conditions. The items 216, 218, 220, 254, and 256 are for illustrative purposes only and do not represent a limitation of the scope of the invention.

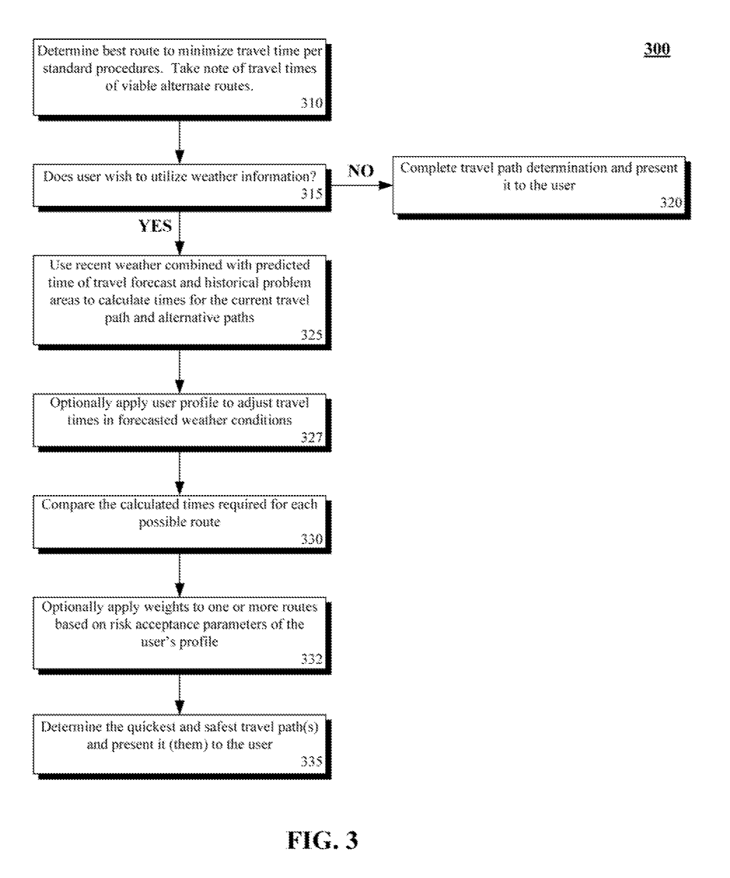

FIG. 3 is a flow chart of a method 300 for a navigation device that selectively uses weather forecasts when determining a quickest travel path. The method 300 can be performed in the context of a system 100 or in the context of any software driven system that determines a travel pathway.

Method 300 can being in step 310, where the navigation device can determine the best route to minimize travel time per standard travel path determination algorithms and procedures. The navigation system can take note of the travel times of each viable alternate route. In step 315, if the user does not wish to utilize weather forecast information, method 300 can end in step 320, where the navigation system can complete the route determination and present it to the user. In step 325, the navigation system can use recent weather combined with predicted time of travel forecast and historical problem areas to calculate times for the current route and alternative routes. In optional step 327, traveler specific characteristics for different weather conditions can be used to adjust the calculated times. In step 330, a navigation system can compare the calculated times required for each possible route, in step 335, the navigation system can determine the quickest and/or safest route and present it to the user, based on the calculated times for each travel path.

It should be appreciated that the navigation device of method 300 can be included in numerous different travel vehicles, each being affected differently by weather conditions. In one embodiment, the navigation system can be a GPS equipped vehicle navigation system for motor vehicles traveling over a highway. Different weather conditions can predict a likelihood of accidents, road flooding, and other events specific to roadways, which effect a driving time for a route. In another embodiment, the navigation system can be a LORAN equipped navigation system of a marine vessel traveling within waterways. Weather conditions, such as storms, can make some waterways in accessible and others non-advisable. Similarly, the navigation system can be included in an airplane, where fog, ice, wind, and other weather conditions are likely to effect flying times. When the navigation device is a mobile device, a user of the device can specify a type of travel (e.g., driving, walking, flying, boating, etc.) and suitable forecasted conditions can be applied that are specific to that type of travel.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that, it carries out the methods described herein.

The present invention: also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A software method for determining a travel path comprising:
identifying a point of origin, a travel destination, and a travel time;
determining a plurality of travel pathways between the point of origin and the travel destination;
ascertaining predicted weather conditions for each of the travel pathways for a time of travel;
adjusting time estimates for each of the travel pathways based on the predicated weather conditions for each of the travel pathways; and
presenting at least one of the determined travel pathways based at least in part upon the time estimates that have been adjusted for the predicted weather conditions, wherein the steps of claim 1 are preformed automatically by a machine in accordance with a set of programmatic instructions stored in a machine readable medium.

2. The method of claim 1 further comprising:
identifying a historical data store of historical information comprising records regarding traffic flow times for portions of the travel pathways, wherein the traffic flow times for equivalent portions of the travel pathways vary based upon a set of associated weather conditions; and
querying the historical data store for relevant records when adjusting the time estimates in the adjusting step.

3. The method of claim 1, further comprising;
receiving user input for one of a plurality of travel mechanisms, wherein the travel pathways are specific to the travel mechanism, wherein the plurality of travel mechanisms comprise at least two mechanisms selected from a group of mechanisms consisting of driving a motor vehicle, locomoting using one's legs, traveling over water in a marine vessel, and flying using a plane.

4. The method of claim 1, wherein the software method is implemented within a motor vehicle navigation system, and wherein the travel pathways comprise roadways.

5. The method of claim 1, further comprising:
a set of user configurable parameters for adjusting results of the adjusting step based at least in part upon a user's driving habits in various different weather conditions.

6. The method of claim 1, wherein the software method is implemented within a global positioning system (GPS) equipped navigation device.

7. The method of claim 6, wherein the ascertaining, adjusting, and presenting steps are repeated to dynamically change the determined travel path as weather forecasts for the predicted weather conditions change.

8. The method of claim 1, further comprising;
a set of user configurable parameters for adjusting results of the adjusting step based at least in part upon a user established level of risk relating to potential delays induced by uncertain weather predictions.

9. The method of claim 1, wherein the set of programmatic Instructions are incorporated in a map generating program accessible via a personal computer.

10. The method of claim 9, wherein the set of programmatic instructions are executed by a Web server, which provides driving maps to the personal computer via a Web browser.

11. A navigation device comprising:
a user interface for inputting a point of origin and a destination and for presenting a programmatically determined travel pathway for traveling from the input point of origin to the destination: and
a travel path determination engine, which is a software based computing engine of the navigation device configured to determine a best travel pathway based at least in part, upon a set of estimated travel time along a plurality of different potential travel pathways, wherein the estimated travel time is based at least in part upon predicted weather conditions, wherein a different travel time results from different predicted weather conditions.

12. The navigation device of claim 11, further comprising:
querying a data store containing records of historical information for points of the travel pathways and travel flow estimates for these points for different weather conditions.

13. The navigation device of claim 12, further comprising:
a global positioning system (GPS) device for automatically determining a current position of the navigation device.

14. The navigation device of claim 13, wherein each of the travel pathways are roadways, and wherein the navigation device is designed for providing driving directions for a motor vehicle.

15. The navigation device of claim 14, wherein the user interface permits a user to establish a set of user configurable parameters for adjusting the estimated travel time based at least in part upon a user's driving habits in various different weather conditions.

16. The navigation device of claim 13, further comprising:
a wireless transceiver for receiving weather forecasts from a weather forecast source, wherein the travel path determination engine automatically re-computes the best travel pathway and the estimated travel time when received weather forecasts cause the predicted weather conditions to change.

17. A system for determining a travel path comprising:
a weather forecast source configured to predict weather conditions;
a mapping data store comprising mapping data configured to be used to determine valid travel paths from a point of origin to a destination;
a historic data store, comprising records indicating travel path portions and estimated times to travel along those travel path portions, wherein different weather conditions are associated with the travel path portions, each weather condition being associated with a different estimated time to travel along the travel path portion in the weather condition; and
a travel path determination engine, which is a software based computing engine configured to determine a travel path using the mapping data store, wherein the determined travel path is one having a shortest duration in view of the predicted weather conditions from the weather forecast source and in further view of the records contained in the historic data store, which are used determine a travel time for the travel path given the predicted weather conditions.

18. The system of claim 17, wherein the travel path determination engine is integrated into a GPS equipped navigation device.

19. The system of claim 17, wherein the travel path determines driving pathways for motor vehicles based upon weather specific conditions of roadways and resulting travel times in light of the weather specific conditions.
